(19) United States
(12) Patent Application Publication
(10) Pub. No.: US 2005/0114735 A1
(43) Pub. Date: May 26, 2005

(54) Systems and methods for verifying core determinacy

(76) Inventors: Zachary Steven Smith, Fort Collins, CO (US); Kevin David Safford, Fort Collins, CO (US); Jeremy P. Petsinger, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/718,123

(22) Filed: Nov. 20, 2003

(51) Int. Cl. G06F 11/00

(52) U.S. Cl. 714/32

(57) ABSTRACT

In one embodiment, a core determinacy verification system and a method pertain to extracting data stored in core model structures, comparing the extracted data of one modeled processor core with extracted data of another modeled processor core, determining if any mismatching data will cause core divergence, and facilitating notice of an error if any mismatching data will cause core divergence.

### BACKGROUND

Computer processor design is an extremely complex and lengthy process. The design process includes a range of tasks from high-level tasks such as specifying the architecture down to low-level tasks such as determining the physical placement of transistors on a silicon substrate. Each stage of the design process also involves extensive testing and verification of the design through that stage. One typical stage of processor design is to program the desired architecture for the processor using a register transfer language (RTL). The desired architecture is represented by an RTL specification that describes the behavior of the processor in terms of step-wise register contents. The RTL specification models what the processor does without describing the physical circuit details. Thus, the processor architecture can be verified at a high level with reference to the RTL specification, independent of implementation details such as circuit design and transistor layout. The RTL specification also facilitates later hardware design of the processor.

Manually verifying the RTL specification of the processor architecture is prohibitively complex during the design of a modern microprocessor. Therefore, multiple test cases are typically generated to test the design. Each test case contains input instructions and may also contain the desired results or outputs. Once created, the test cases may be executed on a simulation of the RTL specification (often compiled to increase speed) and the results analyzed. Through that analysis, errors in the RTL specification, and potentially the processor architecture design, may be identified.

Many processors use multiple processor cores that execute instructions during processor operation. Cores of such processors are connected by an interface, such as a point-to-point (P2P) interface, typically on a single chip. With such a configuration, the processor may be operated in a “lockstep” mode in which two or more of the processor cores execute the same instruction stream each clock cycle. Given that the behavior of the cores is deterministic, the same output should result from each processor core operating in lockstep mode. One advantage of operating in lockstep mode is that if one of the cores experiences an error (e.g., a manufacturing defect, a stuck-at fault, a soft error from an alpha particle, a transient electrical failure, etc.), the other core(s), at least in theory, can continue to execute so that the processor can continue to operate. Assuming that the core that experienced the error has not failed completely, the operating system may be able to resynchronize that core so as to resume normal lockstep operation. In cases in which the cores of a processor are configured to operate in lockstep mode, those cores are typically connected to a lockstep block that monitors the operation of the cores and identifies certain observed errors when they arise.

To properly verify a design of a processor that is configured for lockstep operation, the operation of the modeled processor cores should be evaluated to ensure that each is operating in a deterministic manner, i.e., each core should behave identically given the same input. Although indeterministic (or “indeterminate”) behavior may be detected by the lockstep block, such detection may not occur until far downstream in the execution process. In such a case, it may be difficult to identify the root cause of an eventual divergence of one or more of the processor cores while operating in lockstep mode. Alternatively, the lockstep block may not detect the indeterminate behavior because such behavior does not propagate to the chip interface. In that case, the indeterminate behavior may go undiscovered. Currently, no automated systems or methods for verifying core determinacy are known beyond those that rely upon the lockstep block.

### SUMMARY

Disclosed are systems and methods for verifying core determinacy. In one embodiment, a system and a method pertain to extracting data stored in core model structures, comparing the extracted data of one modeled processor core with extracted data of another modeled processor core, determining if any mismatching data will cause core divergence, and facilitating notice of an error if any mismatching data will cause core divergence.

### BRIEF DESCRIPTION OF THE DRAWINGS

The disclosed systems and methods can be better understood with reference to the following drawings. The components in the drawings are not necessarily to scale.

FIG. 1 is a block diagram of an embodiment of a system for verifying a processor architecture.

FIG. 2 is a block diagram illustrating an example of logical data flow in a point-to-point link network.

FIGS. 3A and 3B comprise a flow diagram of an embodiment of a method for verifying lockstep operation.

FIGS. 4A and 4B comprise a flow diagram of an embodiment of a method for verifying core determinacy.

FIG. 5 is a block diagram of an embodiment of a computer system in which lockstep operation may be verified.

FIG. 6 is a flow diagram of an embodiment of a method for verifying core determinacy.

### DETAILED DESCRIPTION

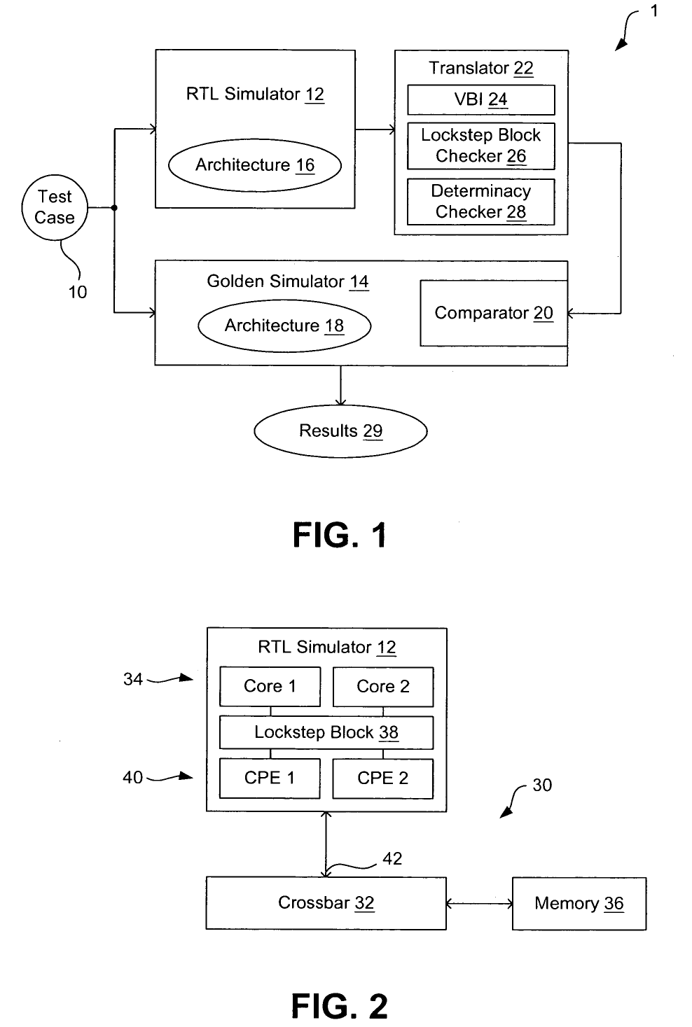

Disclosed are systems and methods for verifying processor core determinacy. Referring to FIG. 1, a processor architecture verification system 1 is illustrated that verifies processor architecture by executing at least one test case 10 on both a register transfer language (RTL) simulator 12 that comprises a compiled version of the RTL specification, and a golden simulator 14 that comprises a relatively high-level program that emulates operation of the processor. It is noted that the golden simulator 14 is not required for core determinacy verification. The golden simulator 14 is shown and identified herein, however, in that it may be useful for other aspects of processor architecture verification beyond core determinacy verification.

The RTL simulator 12 and the golden simulator 14 both simulate the desired processor architecture 16 and 18, respectively. The RTL simulator 12 and the golden simulator 14 may, however, comprise different output interfaces. For instance, the RTL simulator 12 may comprise a point-to-point (P2P) link network output interface while the golden simulator 14 may comprise a front side bus (FSB) output interface. As is described in greater detail below, the modeled architecture 16 includes multiple processor cores that enable lockstep operation, and a lockstep block that monitors the operation of the cores to identify certain errors in core operation when they arise.

Because the output of the RTL simulator 12 and the golden simulator 14 may be in different formats, a translator 22 may be provided that translates the output of the RTL simulator to match the format of the golden simulator 14. The translated output of the RTL simulator 12 can then be compared with the output of the golden simulator 14 in a comparator 20 to produce test results 29. In the illustrated embodiment, the comparator 20 comprises part of the golden simulator 14. Alternatively, however, the comparator 20 may be independent of the golden simulator 14. If any differences in the outputs are detected by the comparator 20, the processor designer is alerted to the fact that an error may exist in the RTL simulator 12 or the golden simulator 14 or both. This enables test cases to be applied to the processor architecture quickly while minimizing required designer attention.

In some embodiments, the translator 22 de-pipelines the output of the RTL simulator 12 for comparison with the output of the golden simulator 14. In such an embodiment, the translator 22 may be referred to as a “depiper”. Such de-pipelining may be necessary because the golden simulator 14 is typically more abstract than the RTL simulator 12. For instance, the golden simulator 14 may not include the same level of detail about the processor architecture being verified as does the RTL simulator 12. The result is that the output of the RTL simulator 12 may not directly match the output of the golden simulator 14 even though the underlying architecture 16, 18 is the same and the test case 10 is identical. A detailed example of a suitable depiper is described in U.S. Pat. No. 5,404,496, which is incorporated by reference herein for all that it discloses.

In the embodiment shown in FIG. 1, the translator 22 comprises a virtual bus interface (VBI) 24 that translates transactions from the RTL simulator 12 from P2P link network format to FSB format for comparison with the FSB format output of the golden simulator 14. In addition to the VBI 24, the translator 22 comprises a lockstep block checker 26 that, as is described in greater detail below, monitors the operation of multiple processor cores (modeled in the architecture 16) as well as the lockstep block when the modeled processor operates in the lockstep mode. Although the lockstep block checker 26 is shown as comprising part of the translator 22 (e.g., depiper), it is noted that the lockstep block checker may be located anywhere (including independent of the translator) in which it may monitor the operation of processor cores and lockstep block during lockstep mode operation. In most embodiments, however, the checker 26 is implemented independent of the golden simulator 14 both to avoid the complexity associated therewith and due to the fact that the golden simulator 14 may be too high level to evaluate (or even be aware of) lockstep operation. In such cases, the lockstep block checker 26 may adjust the output (e.g., state-update packets) so as to fool the golden simulator 14 into “thinking” that only one processor core is running when more than one such core is operating in lockstep mode.

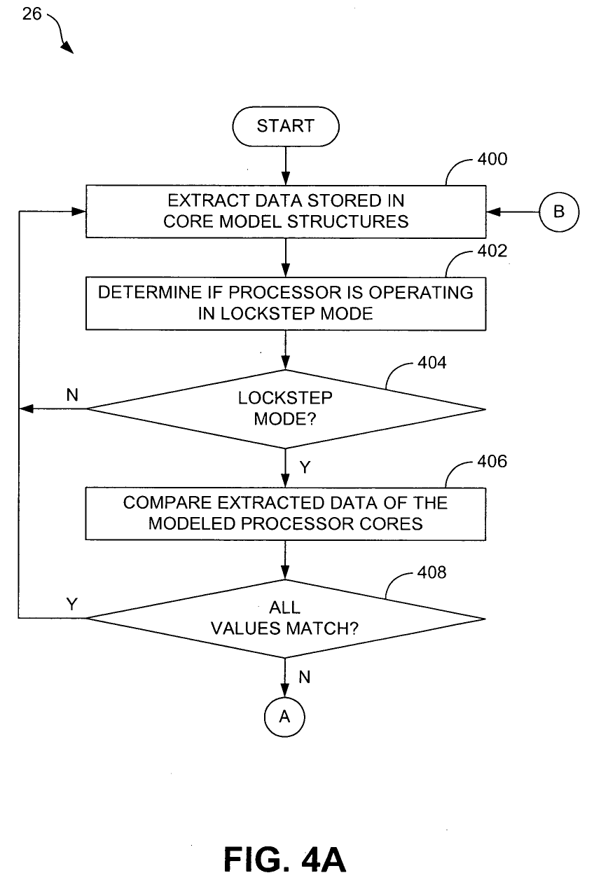

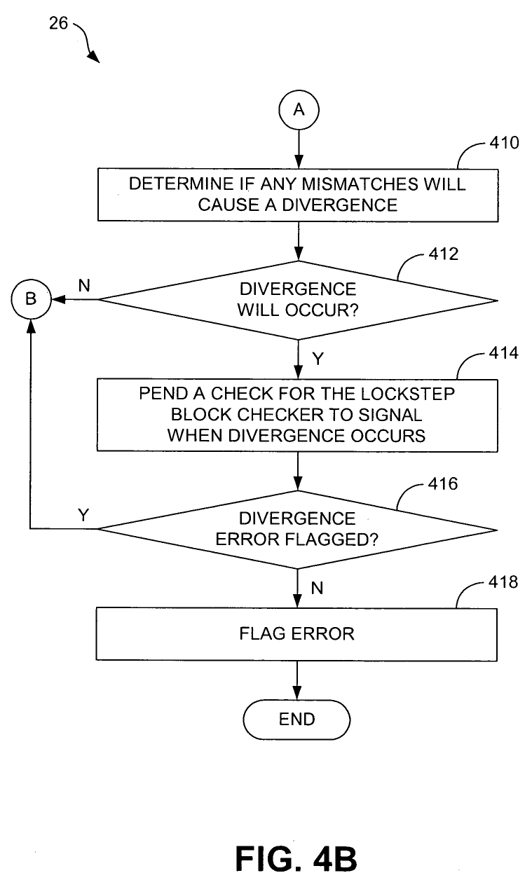

The translator 22 further comprises a determinacy checker 28 that, as is described in greater detail below (e.g., FIG. 4), evaluates the behavior of the modeled processor cores when operating in lockstep mode to ensure that their behavior is deterministic, i.e., that each core will behave in the same manner in terms of output and the timing of that output during lockstep operation. Similar to the lockstep block checker 26, the determinacy checker 28 may be located anywhere (including independent of the translator 22) in which it may monitor the operation of processor cores and lockstep block during lockstep mode operation. In addition, the determinacy checker 28 may monitor the lockstep block checker 26 (see FIG. 4).

The RTL simulator 12 and the golden simulator 14 are operated relative to information specified by the test case 10. By way of example, the test case 10 comprises a program to be executed on the processor architecture 16 and 18 in the RTL simulator 12 and golden simulator 14, respectively. The test case program is a memory image of one or more computer executable instructions, along with an indication of the starting point, and may comprise other state specifiers such as initial register contents, external interrupt state, etc. Accordingly, the test case 10 defines an initial state for the processor that is being simulated and the environment in which it operates. The test case 10 may be provided for execution on the RTL simulator 12 and golden simulator 14 in any suitable manner, such as an input stream or an input file specified on a command line.

The RTL specification used to generate the RTL simulator 12 may be implemented using any suitable tool for modeling the processor architecture 16, such as any register transfer language description of the architecture, which may be interpreted or compiled to act as a simulation of the processor. The RTL simulator 12 of an exemplary embodiment contains an application program interface (API) that enables external programs, including the translator 22, to access the state of various signals in the simulated processor such as register contents, input/outputs (I/Os), etc. Thus, the output of the RTL simulator 12 may be produced in any of a number of ways, such as an output stream, an output file, or as states that are probed by an external program through the API. The RTL simulator 12 may simulate any desired level of architectural detail, such as the processor cores, or the processor cores and one or more output interfaces.

As noted above, the golden simulator 14, when provided, is a relatively abstract, higher-level simulation of the processor architecture, and therefore may be less likely to include faults or errors than the RTL simulator 12. The golden simulator 14 is written using a high-level programming language such as C or C++. Alternatively, the golden simulator 14 may be written using any other suitable programming language, whether compiled, interpreted, or otherwise executed. Whereas the RTL simulator 12 actually matches the details and reality of the processor being simulated to a great degree, the golden simulator 14 typically is a conceptual model without concern for timing considerations arising from physical constraints.

The translator 22 (e.g., depiper) tracks instructions as they flow through the RTL simulator 12 and notes their effects on the simulated processor. The translator 22 may generate a retire record for each instruction that indicates when the instruction started executing and when it completed or retired, along with the states that changed during execution. In some cases, if state changes cannot be tracked to a single instruction, the depiper may generate a generic report identifying an altered state and the instructions that may have caused the change.

In some embodiments in which the translator 22 comprises a depiper, the VBI 24 works in parallel with the depiper, with the depiper producing state change records such as depiper retire records, and the VBI producing state change records in the form of synthesized FSB transactions. Although the VBI 24 may read the P2P packets directly from the P2P interface on the RTL simulator 12 and may access information about the RTL simulated processor via the API, the VBI may also access information about the RTL simulated processor that is stored in the depiper. In some embodiments, the depiper contains structures that monitor the simulated processor cores' states. In such cases, it may be convenient for the VBI 24 to access some information from the depiper for use in reporting or synthesizing fields used in the FSB phases.

In some embodiments in which the translator 22 comprises a depiper, the depiper first reads the P2P output of the RTL simulator 12 and de-pipelines the P2P transactions, generating a de-pipelined version of the P2P transactions. The VBI 24 then reads the de-pipelined version of the P2P transactions from the depiper and generates corresponding FSB transactions for the comparator 20. The de-pipelined P2P transactions may be transferred from the depiper to the VBI 24 in any suitable manner, such as across a virtual P2P link or in a file containing depiper retire records.

Notably, the VBI 24 is not limited to use with verification systems including a depiper. Verification systems having the same level of pipelining detail in both the RTL simulator 12 and the golden simulator 14 may not need a depiper, but a VBI 24 still enables processor simulators with different output interfaces to be used together. If the translator 22 comprises a depiper, the VBI 24 may access information stored in the depiper as described above, or may be implemented as a module in the depiper for convenience. In embodiments in which the translator 22 does not include a depiper, the VBI 24 in the translator still directly connects to the P2P output of the RTL simulator 12, but obtains other information about the state of the simulated processor from the RTL simulator via the API. The VBI 24 uses the resulting P2P packets and other information to produce translated FSB transactions in whatever manner required by the comparator 20, such as generating a virtual FSB connection to the comparator, or generating output reports containing records of FSB format transactions that may be read by the comparator.

FIG. 2 illustrates an example output interface of the RTL simulator 12. As shown in that figure, the RTL simulator 12 uses one or more ports into a point-to-point (P2P) link network 30 shown in FIG. 2. The P2P link network 30 is a switch-based network with one or more crossbars 32 acting as switches between components such as processor cores 34 (i.e., Core 1 and Core 2 in the embodiment of FIG. 2), memory 36, or other devices (not shown). Transactions are directed to specific components and are appropriately routed in the P2P link network 30 by the crossbar 32. The routing provided by the crossbar 32 reduces the load on the system components because they do not need to examine each broadcast block of information. Instead, each component ideally receives only data meant for that component. Use of the crossbar 32 also avoids bus loading issues, thereby facilitating scalability.

Transactions on the P2P link network 30 are packet-based, with each packet containing a header comprising routing and other information. Packets containing requests, responses, and data are multiplexed so that portions of various transactions may be executed with many others at the same time. Transmissions are length limited, with each length-limited block of data called a “flit.” Thus, a long packet will be broken into several flits, and transactions will typically require multiple packets. Therefore, the P2P link network 30 is monitored over time to collect the appropriate P2P packets until enough information exists for a corresponding FSB phase to be generated by the translator 22. To achieve such monitoring, the translator 22 monitors a port 42 on the crossbar 32 that is connected to the cores 34 in the RTL simulator 12. An exemplary read operation in a P2P link network is described in U.S. patent application Ser. No. 10/700,288 (attorney docket number 200209129-1), filed Nov. 3, 2003, which is incorporated herein for all that it discloses.

As is further illustrated in FIG. 2, the RTL simulator 12 includes a lockstep block 38 that resides between the processor cores 34 and their respective core protocol engines (CPEs) 40. The lockstep block 38 monitors outputs of the modeled processor cores 34 (i.e., Core 1 and Core 2 in the embodiment of FIG. 2) to identify when core errors occur. Such errors typically come in two main types. The first type of error comprises an error that the cores 34 detect, i.e., self-detected errors. In such cases, the core 34 experiencing the error (i.e., the failing core) outputs an error message that is intercepted by the lockstep block 38, and the lockstep block ensures that no data from the failing core is output from the processor. In addition, the lockstep block 38 issues a system-level alert that signifies that the failed core must be resurrected to resume lockstep operation.

The other main type of error occurs when no error is detected by a processor core, but different data is output from the cores that are operating in lockstep mode. As noted above, the outputs from the cores should be identical in that the cores' behavior is deterministic and because the cores execute the same instruction streams. Accordingly, when different outputs are detected by the lockstep block 38, one or more of the cores is experiencing an error. In such as case, the lockstep block 38 raises a system-wide error on the interface and further execution is halted and neither core is allowed to send data to the system to prevent system data corruption in that it is not known which of the cores is failing and which is operating correctly.

It is useful to analyze the lockstep block's behavior when verifying a design of a processor. The operation of the lockstep block 38 can be monitored and analyzed using the lockstep block checker 26. The lockstep block checker 26 implements a software model of the lockstep state machine that describes the proper operation the lockstep block 38 in various system states, and monitors the RTL simulator 12 signals that are output from the cores and that are input into and output out of the lockstep block. From those interface signals, the lockstep block checker 26 can evaluate the operation of the lockstep block 38 and identify errors in that operation when applicable. Such an error identifies a potential flaw in the design of the physical lockstep block that will be used in the actual processor.

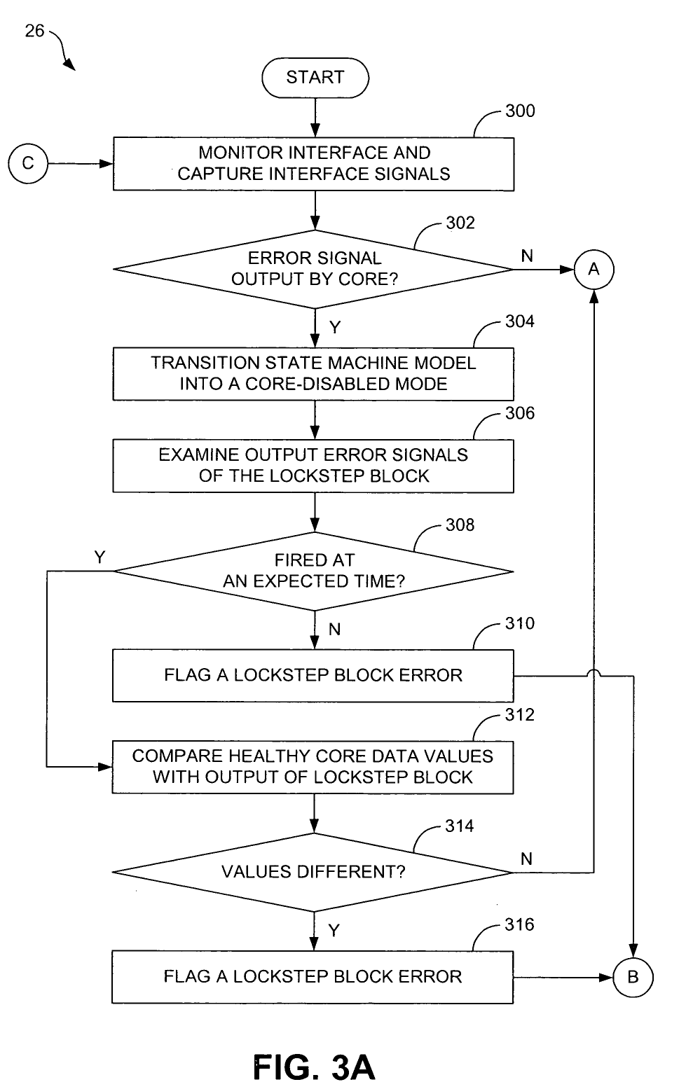

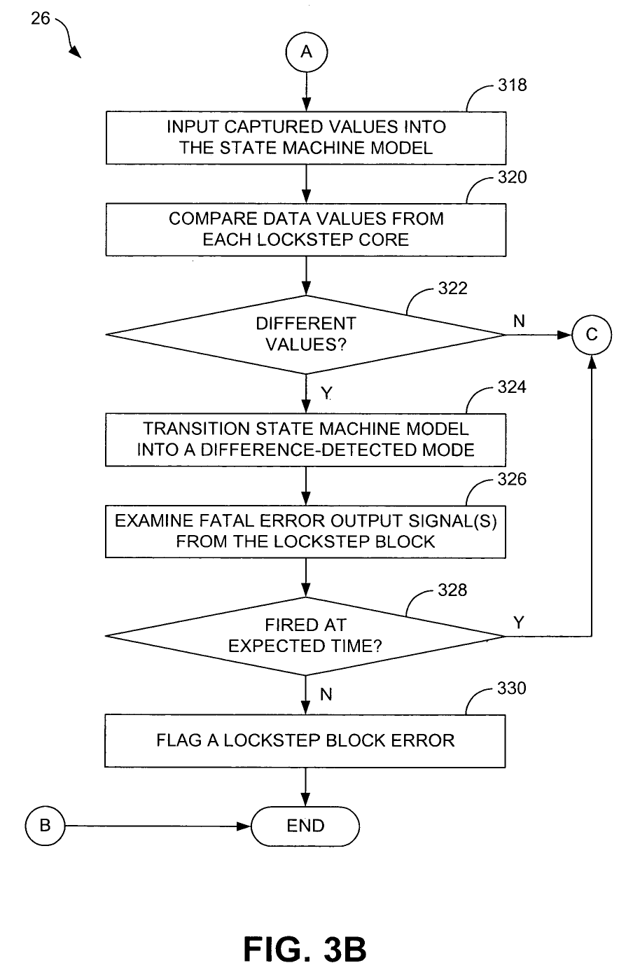

FIG. 3 provides an example embodiment of verifying lockstep operation and, more particularly, of verifying operation of a lockstep block using the lockstep block checker 26. In this example, it is presumed that the system is operating in lockstep mode. By way of example, the flow described in the following is performed once during each clock tick. Beginning with block 300 of FIG. 3, the lockstep block checker 26 monitors the interface (e.g., the P2P interface 30) and captures interface signals that are issued on that interface. Such monitoring is possible in that, because the translator 22 (e.g., depiper) monitors each channel of the P2P interface, the lockstep block checker 26 can access all traffic that is transmitted over the interface. With reference to decision block 302, it can be determined if an error signal is output by a processor core (e.g., Core 1 or Core 2). Such an error signal results from self-detected errors of the cores. If no such error signal is detected by the lockstep block checker 26, flow continues to block 318 of FIG. 3B, which is described below. However, if such an error signal is detected, flow continues to block 304 at which the lockstep block checker 26 transitions its state machine model into a core-disabled mode.

Once the state machine model has been transitioned into the core-disabled mode, the lockstep block checker 26 examines the output error signal(s) of the lockstep block, as indicated in block 306, to determine whether that/those signal(s) fired at an expected time. The expected time is determined by the lockstep block checker 26 using its knowledge of the lockstep block as well as the inputs into the lockstep block. Specifically, in that the configuration and mode of operation of the lockstep block is known (from the state machine model), the lockstep block checker 26 can determine from the inputs into the lockstep block and the time at which those inputs were received by the lockstep block what error signal(s) should be issued by the lockstep block and when. By way of example, the actual process of determining the expected signals and times may comprise accessing a data structure, such as a table, that cross-references input signals (to the lockstep block) with the output signals (from the lockstep block) that should result from the input signals, as well as the times at which the output signals should be output. Alternatively, expected times can be calculated using an appropriate algorithm that has as inputs the input signals and the times at which they were received by the lockstep block. In either case, the time at which an expected signal is expected to fire can be scheduled and the interface can be monitored for those signals.

With reference to decision block 308, if the error signal(s) is/are not fired at the expected time(s), the lockstep block behavior is incorrect and, as indicated in block 310, the lockstep block checker 26 flags a lockstep block error to signal that a problem exists with the lockstep block design (or with the way in which the design has been modeled). Once such an error has been detected and flagged, further testing of the processor architecture may either cease or continue. For the purposes of this example, however, it is assumed that the occurrence of such an error causes testing to cease, in which case flow for the session is terminated (see reference B in FIGS. 3A and 3B).

With reference back to decision block 308, if the error signal(s) is/are fired at the expected time(s), the lockstep block reacted appropriately in relation to the error signal output by the failing core. In such a case, flow continues to block 312 at which the data values output by the “healthy” core(s), i.e., the core(s) that did not output the error signal, are compared with the data output of the lockstep block (i.e., data enroute to a CPE 40). Again, given that the lockstep block checker 26 knows the configuration of the lockstep block and the manner in which the block is supposed to operate, the lockstep block checker can determine the proper output of the lockstep block based upon the input provided to the block (i.e., the output from the healthy core(s)). With reference to decision block 314, if the values output from the lockstep block differ from the values that the lockstep block checker 26 is expecting, the lockstep block checker assumes that the lockstep block is not functioning properly and, therefore, flags a lockstep block error, as indicated in block 316. Again, flow may then terminate at that point.

If the values output by the lockstep block match those expected by the lockstep block checker 26 in decision block 314, or if no error signal was output by a core in decision block 302, flow continues to block 318 of FIG. 3B. As indicated in that block, the lockstep block checker 26 next inputs the captured values (see block 300 of FIG. 3A) into its state machine model. Through such input, the lockstep block checker 26 can compare the data values from each lockstep core, as indicated in block 320, so that the checker can determine whether the cores are producing the same outputs, in which case they are assumed to be working properly, or producing different outputs, in which case at least one of the cores is failing. By way of example, this comparison can be conducted using an XOR tree.

With reference next to decision block 322, if different values are not observed by the lockstep block checker 26, flow reverts back to block 300 of FIG. 3A at which monitoring and the flow described above resumes. By way of example, such flow may occur during the next clock tick. If, on the other hand, different values are observed, flow continues to block 324 at which the lockstep block checker 26 transitions the state machine model into a difference-detected mode. Once the state machine model is transitioned into that mode, the lockstep block checker 26 examines the fatal error output signal(s) (e.g., BINIT signals) from the lockstep block, as indicated in block 326. In particular, the lockstep block checker 26 determines, from the outputs of the cores, when such signals are expected. Therefore, with reference to decision block 328, the lockstep block checker 26 can determine whether the signal(s) fired at the expected time. If so, the lockstep block has performed correctly and flow can return to block 300 of FIG. 3A. If not, however, the lockstep block has operated incorrectly and, therefore, the lockstep block checker 26 flags a lockstep block error, as indicated in block 330.

FIGS. 4A and 4B provide an example embodiment of verifying lockstep operation and, more particularly, of verifying core determinacy using the determinacy checker 28. By way of example, the flow described in the following is performed once during each clock tick. Beginning with block 400 of FIG. 4A, the determinacy checker 28 extracts data stored in various entries of the core model structures. The structures comprise core data storage and interconnect elements. By way of example, target structures may comprise core buffers including registers, translation lookaside buffers (TLBs), core caches, core queues, core state variables, core state machines, and bus values. Such extraction results in the collection of many data values, on the order of thousands to tens of thousands, that may be used to compare operation of the modeled processor cores.

With reference to block 402, the determinacy checker 28 determines if the modeled processor is operating in lockstep mode. That determination can be made by analyzing the lockstep block and/or the lockstep block checker. For instance, the determination can be made with reference to the mode of operation of the state machine model of the lockstep block checker (see discussion of FIGS. 3A and 3B). Notably, the determination as to whether the processor is operating in lockstep mode can be made prior to extracting data (block 400). In such a case, operation of the determinacy checker 28 may terminate (at least for the instant clock cycle) upon determining that lockstep mode is not active.

Referring next to block 404, if lockstep mode is not active, flow returns to block 400 so that new data may be extracted, for instance during the subsequent clock tick. If lockstep mode is active, i.e., two or more processor cores are operating in lockstep mode, flow continues to block 406 at which the determinacy checker 28 compares the extracted data of the processor cores. For example, if two processor cores are operating in lockstep mode, the extracted data from those two cores are compared with each other. From such comparison, it can be determined whether all of the values match, or whether one or more values do not match (i.e., are mismatched). With reference to decision block 408, if all values match, the cores' behavior is identical and, therefore, the cores are determinant. In such a case, flow returns to block 400 (e.g., for the next clock tick).

If one or more of the compared values do not match, however, the behavior of the cores may or may not be deterministic. Therefore, at this point, the determinacy checker 28 determines if any of the mismatches can cause core divergence, as indicated in block 410 of FIG. 4B. That determination can be made with reference to a data structure, such as a lookup table, that cross-references results (i.e., divergence or not) with the given mismatched values, or through use of an appropriate algorithm that uses the mismatched values as inputs. Although mismatches are undesirable, certain mismatches may be waived because they are unlikely to cause divergence. In other words, it is possible for the cores to have some structure differences due to random initial values or an error that a core experienced that will be remedied through continued operation (i.e., the difference will be overwritten with deterministic data before propagating to an interface observable by the lockstep block). For example, a single bit error in an error-correcting code (ECC) protected structure that is automatically corrected in lockstep mode is not indicative of a determinacy problem that will result in core divergence. Generally speaking, there are two main cases of structure/bus mismatches that can be waived as not indicative of probable divergence. The first case is when the data is different because of a random initialization (i.e., from power up) and the data will be overwritten later or will never be consumed (e.g., an invalid bit set). The second case is when there is an error that is dynamically corrected in such a manner as to retain lockstep operation. On the other hand, mismatching data may be the result of a bug in the RTL specification, i.e., a determinism bug, that will ultimately result core divergence that will impede lockstep operation.

Referring now to decision block 412, if the determinacy checker 28 determines that divergence will not occur given the nature of the mismatch (i.e., the mismatch may be waived), flow returns to block 400 of FIG. 4A. If a divergence will occur, however, i.e., if the mismatch will cause the cores to diverge, flow continues to block 414 at which the determinacy checker 28 pends a check for the lockstep block checker 26 to signal when divergence occurs. The lockstep block checker 26 can therefore monitor the operation of the modeled processor cores (see FIGS. 3A and 3B) to confirm that the divergence does in fact occur. Upon such occurrence, the lockstep block checker 26 can flag a divergence error. With reference to decision block 416, if the lockstep block checker 26 does not flag such an error, i.e., the pended check is not satisfied because the lockstep block checker was not able to observe the divergence, the determinacy checker 28 can flag an error, as indicated in block 418. At this point, operation for the determinacy checker 28 is terminated, at least until the cores have been resynchronized and lockstep operation is resumed.

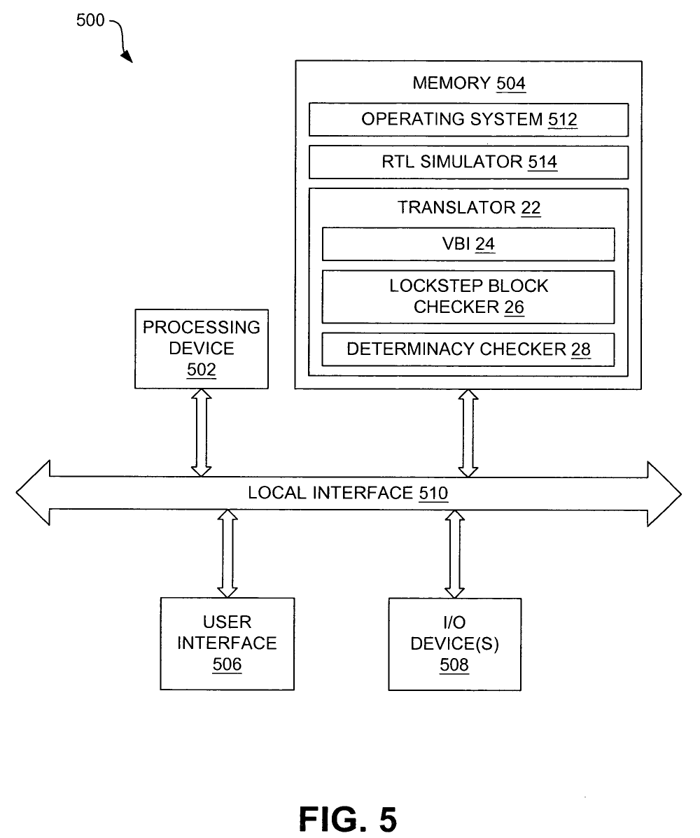

FIG. 5 is a block diagram of a computer system 500 in which the foregoing systems can execute and, therefore, a method for verifying lockstep operation can be practiced. As indicated in FIG. 1, the computer system 500 includes a processing device 502, memory 504, at least one user interface device 506, and at least one input/output (I/O) device 508, each of which is connected to a local interface 510.

The processing device 502 can include a central processing unit (CPU) or an auxiliary processor among several processors associated with the computer system 500, or a semiconductor-based microprocessor (in the form of a microchip). The memory 504 includes any one or a combination of volatile memory elements (e.g., RAM) and nonvolatile memory elements (e.g., read only memory (ROM), hard disk, etc.).

The user interface device(s) 506 comprise the physical components with which a user interacts with the computer system 500, such as a keyboard and mouse. The one or more I/O devices 508 are adapted to facilitate communication with other devices. By way of example, the 1/0 devices 508 include one or more of a universal serial bus (USB), a Firewire, or a small computer system interface (SCSI) connection component and/or network communication components such as a modem or a network card.

The memory 504 comprises various programs including an operating system 512 that controls the execution of other programs and provides scheduling, input-output control, file and data management, memory management, and communication control and related services. In addition to the operating system 512, the memory 504 comprises the RTL simulator 12 and the translator 22 identified in FIG. 1. As is shown in FIG. 5, the translator 22 includes the VBI 24, the lockstep block checker 26, and the determinacy checker 28, each of which have been described in detail above.

Various programs (i.e., logic) have been described herein. Those programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

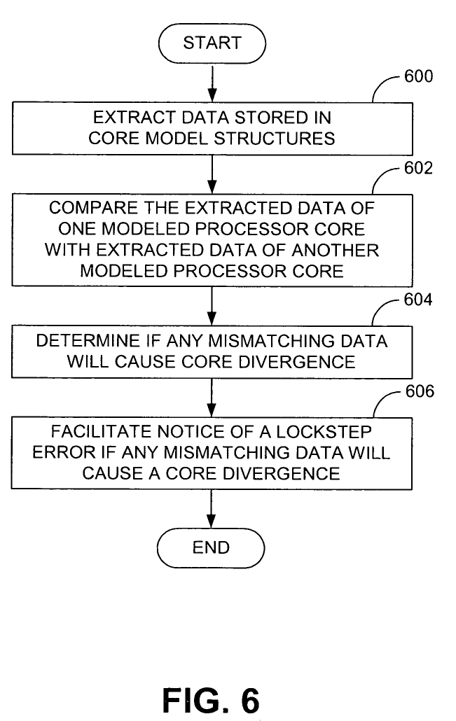

In view of the above, a method for verifying core determinacy is provided in FIG. 6. As indicated in that figure, the method comprises extracting data stored in core model structures (block 600), comparing the extracted data of one modeled processor core with extracted data of another modeled processor core (block 602), determining if any mismatching data will cause core divergence (block 604), and facilitating notice of an error if any mismatching data will cause core divergence (block 606).

1. A method for verifying core determinacy, the method comprising:
extracting data stored in core model structures;
comparing the extracted data of one modeled processor core with extracted data of another modeled processor core;
determining if any mismatching data will cause core divergence; and
facilitating notice of an error if any mismatching data will cause core divergence.

2. The method of claim 1, wherein extracting data comprises extracting data from core data storage and interconnect elements.

3. The method of claim 2, wherein extracting data comprises extracting data from at least one of core buffers, core caches, core queues, core state variables, core state machines, and bus values.

4. The method of claim 1, wherein determining comprises accessing a data structure that matches divergence results with given mismatched data.

5. The method of claim 1, wherein determining comprises implementing an algorithm that uses the mismatched data as inputs.

6. The method of claim 1, wherein facilitating notice comprises pending a check for a lockstep block checker to signal when divergence occurs.

7. The method of claim 6, wherein facilitating notice comprises flagging an error if the lockstep block checker does not signal that divergence occurred.

8. The method of claim 1, further comprising determining if a modeled processor is operating in lockstep mode.

9. The method of claim 8, wherein determining if a modeled processor is operating in lockstep mode comprises analyzing at least one of a lockstep block and a lockstep block checker.

10. A system for verifying core determinacy, the system comprising:
means for determining if a modeled processor is operating in a lockstep mode;
means for extracting data stored in core model structures;
means for comparing the extracted data to determine if any data associated with one processor core does not match data associated with another processor core; and
means for determining if any mismatching data will cause core divergence.

11. The system of claim 10, wherein the means for determining if a modeled processor is operating in a lockstep mode comprise means for analyzing at least one of a lockstep block and a lockstep block checker.

12. The system of claim 10, wherein the means for extracting data comprise means for extracting data from core data storage and interconnect elements.

13. The system of claim 10, wherein the means for determining if any mismatching data will cause core divergence comprise at least one of a data structure and an algorithm.

14. The system of claim 10, further comprising means for pending a check for a lockstep block checker to signal when divergence occurs.

15. The system of claim 10, further comprising means for flagging an error.

16. A determinacy checker stored on a computer-readable medium, the system comprising:
logic configured to determine if a modeled processor is operating in a lockstep mode;
logic configured to extract data stored in core model structures;
logic configured to compare the extracted data;
logic configured to determine if any data associated with one processor core does not match data associated with another processor core;
logic configured to determine if any mismatching data will cause core divergence; and
logic configured to facilitate notification of an error if any mismatching data will cause core divergence.

17. The checker of claim 16, wherein the logic configured to determine if a modeled processor is operating in a lockstep mode comprises logic configured to analyze at least one of a lockstep block and a lockstep block checker.

18. The checker of claim 16, wherein the logic configured to extract data comprises logic configured to extract data from core data storage and interconnect elements.

19. The checker of claim 16, wherein the logic configured to determine if any mismatching data will cause core divergence comprises logic configured to access at least one of a data structure that matches divergence results with given mismatched data and an algorithm that uses the mismatched data as inputs.

20. The checker of claim 16, wherein the logic configured to facilitate notification comprises logic configured to pend a check for a lockstep block checker to signal when divergence occurs.

21. The checker of claim 16, wherein the logic configured to facilitate notification comprises logic configured to flag an error.

22. A computer system, comprising:
a processing device; and
memory including a determinacy checker that is configured to extract data stored in core model structures, compare the extracted data, determine if any mismatching data will cause core divergence, and facilitate notification of an error if the mismatching data will cause core divergence.

23. The system of claim 22, wherein the checker is configured to extract data from core data storage and interconnect elements.

24. The system of claim 22, wherein the checker is configured to pend a check for a lockstep block checker to signal when divergence occurs.

25. The system of claim 22, wherein the checker is configured to flag an error.
